(19) United States
(12) Patent Application Publication
(10) Pub. No.: US 2025/0337589 A1
(43) Pub. Date: Oct. 30, 2025

(54) HARDWARE ASSISTED ARTIFICIAL INTELLIGENCE MODEL ATTESTATION

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (IT); Satoru Tagaya, Barcelona (ES); Erich Ludwig Focht, Stuttgart (DE); Akira Tsukamoto, Barcelona (ES)

(21) Appl. No.: 19/263,091

(22) Filed: Jul. 8, 2025

Related U.S. Application Data
(63) Continuation of application No. PCT/EP2025/057854, filed on Mar. 21, 2025.

(51) Int. Cl. H04L 9/32; H04L 9/08

(52) U.S. Cl. CPC H04L 9/3236; H04L 9/0825

(57) ABSTRACT

Aspects of hardware assisted artificial intelligence (AI) model attestation are described. A facility in a system, such as an AI accelerator chiplet in a chiplet assembly, can obtain an AI model for execution. The facility can derive a set of identifiers for the AI model and search a local repository to determine whether the AI model is already registered with the facility. Registration indicating that attestation verification has already been successfully completed. If the AI model is not registered, the facility can communicate the set of identifiers to an attestation authority and receive a confirmation from the attestation authority whether the AI model is authentic. If the AI model is authentic, then the facility registers the AI model.

### PRIORITY

This application is a continuation of International Application No. PCT/EP2025/057854, filed Mar. 21, 2025, which is incorporated herein by reference in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

Artificial Intelligence (AI) models are computational systems designed to simulate human intelligence by processing data, recognizing patterns, or making decisions or predictions. These models are iteratively constructed from large datasets, enabling them to perform tasks such as image recognition, natural language processing, or decision-making. AI models can range from simple linear regressions to complex neural networks, including deep learning architectures like Convolutional Neural Networks (CNNs) for image analysis or Transformer-based models for semantic language processing. The creation of AI models generally involves training them on vast amounts of data to optimize their performance (e.g., accuracy), after which the AI model can be deployed in various applications. The continuous improvement of these models through techniques like reinforcement learning and transfer learning has expanded their capabilities and potential impact across industries.

AI model accelerator hardware is a class of computing devices designed to enhance the performance or efficiency of artificial intelligence workloads by optimizing tasks such as matrix operations, tensor computations, and parallel processing. These accelerators, which include Graphics Processing Units (GPUs), Tensor Processing Units (TPUs), or Field-Programmable Gate Arrays (FPGAs), and other xPU based processing units, enable higher throughput and lower latency compared to traditional Central Processing Units (CPUs). AI accelerators leverage architectures optimized for deep learning frameworks, supporting operations such as convolutional neural network inference, natural language processing, or large-scale data analytics. Many modern AI accelerators integrate with high-speed interconnects such as Compute Express Link (CXL) to enable scalability and composability in distributed computing environments.

In the context of computing systems, attestation is the process of verifying the integrity, authenticity, or trustworthiness of a system or software component. This verification is typically performed using cryptographic techniques to ensure that the software has not been tampered with and is running in a secure and expected state. Attestation can be either local or remote, where local attestation involves verification within the same system, while remote attestation enables an external entity to validate the system's integrity. Trusted computing technologies, such as Trusted Platform Modules (TPMs) or remote attestation frameworks in Confidential Computing, use attestation to establish a root of trust. This process can be used in cloud computing environments, secure boot processes, or hardware security modules, where ensuring the legitimacy of the software environment is important to maintaining security or compliance.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts a chiplet system with hardware assisted AI model attestation, according to an embodiment.

FIG. 2 depicts components interactions in AI model attestation, according to an embodiment.

FIG. 3 depicts a processing flow for AI model attestation, according to an embodiment.

FIG. 4 depicts components interactions in AI model attestation, according to an embodiment.

FIG. 5 depicts an example of an architecture for AI model attestation, according to an embodiment.

FIG. 6 depicts component interaction for validating data for use with an attested AI model, according to an embodiment.

FIG. 7 depicts a method for hardware assisted artificial intelligence model attestation, according to an embodiment.

FIG. 8 depicts a hardware arrangement of a data center used to provide multiple implementations or instances of a computing system, according to an example.

FIGS. 9A and 9B depict arrangements of a chip assembly with expanded views of the chiplets and processing units, according to an example.

FIG. 10 depicts a block diagram of a computing system, according to an example.

### DETAILED DESCRIPTION

Security has been a growing focus in system and infrastructure design over the past decades to mitigate risks, including infrastructure downtime, unauthorized access to sensitive information, or financial asset attacks. Ensuring secure systems and infrastructures has been approached through a variety of techniques, including a design philosophy that integrates security considerations at both the system and infrastructure levels. Any vulnerability in the system design can serve as an entry point for potential attacks, emphasizing the need for a comprehensive security framework to protect against emerging threats.

Related to general computer security, enabling a user to maintain control over their own data has become increasingly important. This user control can include determining what data is kept by a data provider, how that data is used, or preventing unauthorized access or misuse. Advances in cryptographic techniques, such as end-to-end encryption or zero-knowledge proofs, have enabled users to store and share data while preserving privacy. Federated identity management systems, such as OAuth or OpenID Connect, have improved user authentication by reducing reliance on centralized credential storage. Additionally, decentralized data storage models, including Solid (Social Linked Data) and blockchain-based solutions, have provided users with more granular control over data access and permissions. Privacy-enhancing technologies, such as homomorphic encryption and secure multi-party computation, further enable computations on encrypted data without exposing raw information. These technical advancements contribute to a security paradigm where user data control is reinforced at both the architectural and operational levels.

Recent advances in AI raise new issues in user data control techniques. Existing technologies are insufficient to implement trusted artificial intelligence (AI) designs. For example, current European AI proposals involve disconnected components referred to as “AI asteroids,” including AI models, AI runtimes, and hardware accelerators. These components function independently without an integrated system-level approach. AI models are often developed using data collected from multiple sources without sufficient validation or control. Many AI-driven applications, such as those used in traffic management or education, rely on unverified models or datasets, leading to potential issues related to accuracy, security, or ethical concerns. Additionally, AI deployment models lack coordinated hardware, software, and infrastructure co-designs that ensure the integrity of their functionality and prevent tampering or unauthorized data access.

In general, current of AI systems lack sufficient control over the AI software stack. AI models operate on compute elements such as processors, but these models are not validated by the underlying hardware. Once installed, AI models are simply accessed by the software stack without verification. Furthermore, AI runtimes, whether inside accelerators or on host systems, generally do not undergo attestation processes, leaving them vulnerable to potential compromise.

To address these issues, devices and techniques for hardware assisted AI model attestation are described herein. This can be considered a co-design approach that integrates software and hardware to enable both applications and users to attest to the AI models or runtimes running on a system. Hardware assisted AI model attestation can use an external entity, such as a server, that provides application programming interfaces (APIs) for attesting AI models or runtimes, and hardware APIs that enable the software stack or end users to perform hardware-assisted runtime attestation. In an example, software support can interface with these hardware APIs, ensuring that AI models or runtimes operate within a secure and verifiable execution environment. In broad strokes, the hardware can maintain a list of registered AI models that have passed attestation from a trusted service. When inference or other processing using the AI model is instructed (e.g., via a software instruction), the hardware can check this list and proceed if the model is registered. However, if the model is not registered, the hardware can query the trusted service with aspects of the AI model to determine whether the model is true and correct. If the trusted service attests to the authenticity or correctness of the AI model, the hardware can register the AI model (e.g., with an AI accelerator of a system or chiplet platform, or collection of components, such as a processor or compute element, that makeup or participate in these structures) and proceed to execute the instruction to use the AI model. Otherwise, the hardware can prevent the AI model from being used. In this manner, the hardware supports control over AI model execution to prevent malicious or flawed AI models from compromising the security of a computer system. Additional details and examples are provided below.

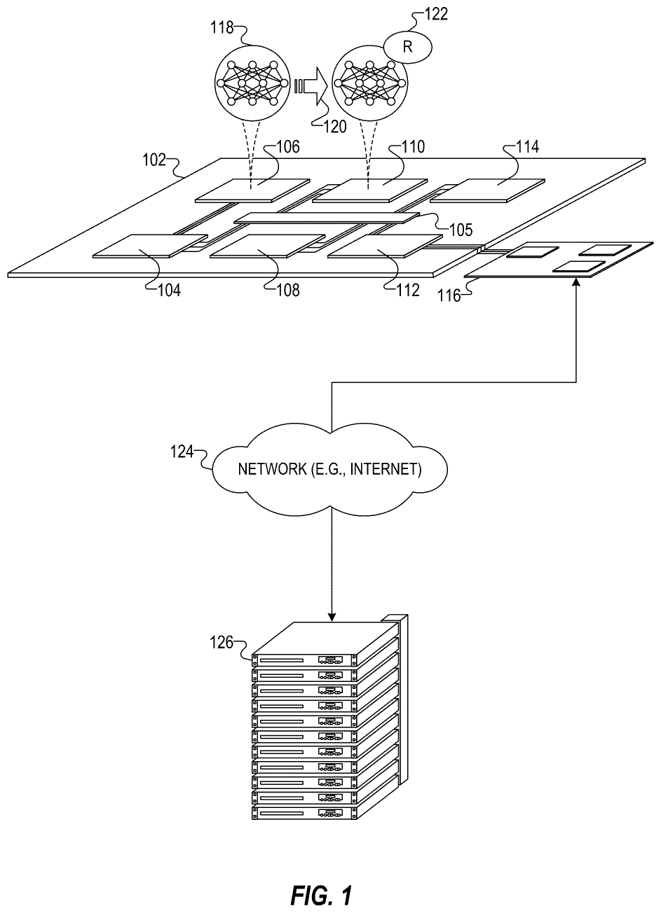

FIG. 1 depicts a chiplet system with hardware assisted AI model attestation, according to an embodiment. As illustrated, the chiplet system can include a chiplet package 102 (e.g., an SoC, SiP, SoP, chiplet assembly, etc.) that includes a compute tile 104, memory 106 (e.g., random access memory (RAM)), a data movement accelerator 108, a media or AI accelerator 110, sensor processor 114, and an off-package interface 112 (e.g., a compute express link (CXL) interface). As illustrated, the compute tile 104 is directly connected to the memory 106—such as via a double data rate (DDR) memory interface, a High Bandwidth Memory (HBM) interface, Universal Memory Interface (UMI), or Bunch of Wires (BoW) interface, etc.—the off-package interface 112 is connected to an external component 116, such as a network interface, and the remaining components communicate via an input-output (IO) hub 105 (e.g., operating in accordance with a Universal Chiplet Interconnect Express (UCIe) family of standards) of the chiplet package 102. The external component 116 can enable connectivity via a network 124 to other systems, such as computer system 126, in a data center or in another arrangement via a variety of networking protocols, such as an IEEE 802.3 family of standards (e.g., Ethernet) or IEEE 802.11 family of standards (e.g., Wi-Fi) among others.

The following examples are from the perspective of processing circuitry of the AI accelerator 110. The AI accelerator also has an interface to communicate beyond the chiplet (e.g., via the IO hub 105) and memory (or storage) to maintain a local repository. The illustrated scenario involves loading 120 (e.g., transferring, writing, etc.) an AI model 118 from the memory 106 to the AI accelerator 110 (e.g., instructed by software running on the compute tile 104) for execution (e.g., invocation, inferences, training, etc.). The computer system 126 includes an attestation authority for the AI model 118 that is accessible to the processing circuitry to perform attestation on the AI model 118. The illustrated scenario involves a successful conclusion to the attestation process such that the AI model 118 becomes a registered AI model 122 in the AI accelerator 110. In general, the AI accelerator 110 will run the registered AI model 122 but will not run the AI model 118 otherwise.

While the following examples operate from the perspective of processing circuitry of the AI accelerator 110, other configurations can be used. For example, a second chiplet can perform the attestation interactions to determine whether the AI model 118 is a registered AI model 122. In general, if the AI model 118 is not executed (e.g., used for inference, output, etc.) without being the registered AI model 122, the arrangement of the circuitry performing this gateway activity is of no particular importance, such that any compute element can perform the attestation, registration, or otherwise validate the AI model 118 for execution.

The processing circuitry is configured to obtain (e.g., receive, retrieve, access, read, etc. via the interface of the AI accelerator 110) the AI model 118 for execution on the AI accelerator 110 (or another chiplet of the chiplet package 102) chiplet. Here, acquiring the AI model 118 can include receiving an address or an address range in the memory 106 in which the AI model 118, or a portion thereof, is being stored. In an example, obtaining the AI model 118 can include receiving bits or another representation of the AI model 118 through the IO hub 105 from another chiplet, such as the compute tile 104 or the off-package interface 112. As noted below, aspects of the AI model 118 are used by the processing circuitry to identify the AI model 118 to the attestation authority on the computer system 126.

Attestation can be performed in multiple ways to verify the integrity of the AI model 118. In an example, attestation can also be used to and the authenticity of the creator of the AI model 118. A straightforward approach can include generating a hash (e.g., a cryptographic hash) of the AI model 118 to use as proof of identity (e.g., the AI model 118 is what it is represented to be). However, while cryptographic hashes serve as a compact representation of the AI model 118, collisions (e.g., two different AI models having the same hash) are mathematically possible due to mapping large inputs to smaller outputs. Thus, it is theoretically possible that attackers can alter the AI model 118 in such a way that the hash is the same as an unaltered version of the AI model 118. Increasing the complexity or size of the hash function can make such collisions more difficult to achieve. In an example, combining the hash with one-time values—such as, a salt, nonce, or an initialization vector (e.g., provided by the attestation authority)—can address exploits by helping to ensure freshness, preventing reuse of an old valid hash for fraudulent purposes.

Other features of the AI model 118 can be used instead of, or in addition to, a hash to serve as proof of identity. For example, the set of identifiers can include the entire definition (e.g., all weights and parameters) of the AI model 118. This approach can be infeasible for large models due to the large amount of data needed to define these large models. In an example, the set of identifiers can include a proper subset (e.g., less than all) of the definition of the AI model 118. This proper subset can include a proper subset of neuron weights or parameters. In an example, the attestation authority provides a selection of neuron weights or parameters that are included in the set of identifiers. Thus, the attestation authority can request different subsets for each attestation. In an example, randomization can be used to select elements of the definition of the AI model 118 to include in the set of identifiers. For example, the attestation authority can request a random five percent of the parameters of the AI model 118. In an example, these random parameters can be accessed (e.g., selected, identified, etc.) based on a selection of a function that uses a random seed. Here, a different function can be used to further vary the selected elements for different attestation attempts, for example. For example, a function, such as selection (seed_number, parameter_number), can be chosen from a set of such functions. The local attestation can select a seed randomly and can start collecting definition for selection (seed_number, parameter_number). Accordingly, if the attestation requires that a 1,000 parameters the AI model 118 should be sent, the function can iteratively execution the function selection (seed_number, parameter_number) to identify the parameters and then collect the parameters to send to the attestation authority. This randomized sampling can provide sufficient evidence of integrity of the AI model 118 without requiring transfer of the entire AI model 118.

With respect to determining authorship of the AI model 118, digital signatures can be used, for example, in tandem with hashing. Here the hash generated from the AI model 118, (e.g., possibly incorporating the aforementioned one-time values, metadata, or other information as defined by the attestation protocol) can be signed with a private key of the entity that created or owns the AI model 118. Once this is complete, any other entity can verify authenticity of authorship with the public key that corresponds to the private key. This dual approach of verifying both integrity and authorship ensures that the AI model 118 is unaltered from the intended version and that the AI model 118 comes from the correct source.

To gather information to provide the proof of identity, the processing circuitry is configured to derive (e.g., compute, extract, retrieve, measure, aggregate, calculate a statistical result) a set of identifiers for the AI model 118. The set of identifiers includes information that identifies the AI model 118 in a preferably unambiguous manner. For example, the set of identifiers can include a hash (e.g., a cryptographic hash) of the AI model 118 (or the portion of the AI model 118 being loaded (e.g., loading 120) onto the AI accelerator 110). Hashes in general can serve as a compact representation for the AI model 118. A cryptographic hash can also ensure that the content of the AI model 118 is the same no matter what entity computes the cryptographic hash. This type of “fingerprinting” can ensure that valid copies of the AI model 118 have the same hash value whereas invalid copies do not.

As noted above, the use of a hash can be combined with, or supplanted by, other pieces of information about the AI model 118 to make up the set of identifiers. These other pieces of information can include the previously mentioned techniques of selecting a complete definition of the AI model 118 or a proper subset of the definition of the AI model 118. This proper subset can include weights or parameters of a set of neurons in the AI model 118. In an example, the attestation authority provides a selection (e.g., map, identification, etc.) of the members of the proper subset. In an example, the attestation authority defines (e.g., selects) a function that selects the members of the proper subset. This is an example of an interactive selection of the set of identifiers where one or more exchanges between the attestation authority and the processing circuitry occur to establish the parameters of the additional data selection. For example, the attestation authority can transmit a set of neuron identifiers to the processing circuitry in a first communication, receive a response with the weights of these identified neurons, then send identification of a function to be run against the definition of the AI model 118, and then receive the output of the function in response. In these interactions, the attestation authority has a result locally that can be tested against the responses by the processing circuitry to determine whether the responses match the local results. Generally, matches (e.g., within a predefined threshold) mean that the integrity of the AI model 118 is intact and other results (e.g., non-matches or matches outside of the predefined threshold) mean that the integrity of the AI model 118 is not intact.

Additional data about the AI model 118 can include metadata of the model. In an example, the set of identifiers includes a model identifier, a version, or a producer of the model. These types of identifiers can provide demographic information for the AI model 118. In general, these identifiers in the set of identifiers provide a mechanism for another party, such as the attestation authority, to know that the AI model 118 is the same model it is purported to be and also that the AI model 118 is unaltered.

In an example, the set of identifiers can include records, or derivations thereof, of previous performance of the AI model 118. Such performance records can include a result based on predefined testing input data, resource use, devices accesses, etc. These identifiers in the set of identifiers can provide insight into performance characteristics (e.g., behavior) of the AI model 118. Such information can not only be used to help verify that the AI model 118 is valid, but also to provide information for future determinations on whether the model is performing as designed. For example, while a supply chain for the AI model 118 can be verified, it can be difficult to determine that malicious training data was not used to corrupt the AI model 118 in subtle ways. As additional vectors for malicious training data are identified, the behavior characteristics of the AI model 118 can be used to identify whether the model is or is not compromised.

The processing circuitry is configured to search a local repository to determine that the AI model 118 is not registered with the AI accelerator 110 (or another chiplet). While this assumes that the AI model 118 is not registered, if the registered AI model 122 exists, then the processing circuitry can go ahead and perform any request against the registered AI model 122; that is, when the AI model 118 is already registered, then the AI model 118 can be executed.

The local repository is hosted in memory or storage located within, or under the exclusive control, of the processing circuitry. In an example, a Trusted Execution Environment (TEE) or other similar set of structures in the AI accelerator 110 can be used to host or to secure the information in the local repository. The local repository can be arranged in a variety of ways. For example, the local repository can be a database, lookup table, linked list, stack, queue, binary tree, or other data structure that enables the searching (e.g., by an index, linearly, etc.) for a value.

The value used for the search can include a non-zero subset (e.g., including a proper subset) of the set of identifiers. For example, a limited hash of the AI model 118 can be used as a lookup key for the local repository. This technique can provide an efficient (especially with hardware supported hashing) technique that avoids additional records (e.g., metadata), the technique can suffer if, for example, metadata changes for the AI model 118. For example, if the AI model 118 includes a “last run” metadata field, then the hash is likely to vary each time the hash is computed unless such metadata is excluded. Thus, in an example, the subset of the set of identifiers can include a key specified in the metadata of the AI model 118, such as a name, a serial number, or even an assigned designation from the attestation authority. In an example, the search matches more than one value from the subset of identifiers. This can be referred to as a key set. In general, all members of the key set are required to match values in a record of the local repository for the search to return the record. In contrast, it can be possible that only some of the subset of the set of identifiers match for the record to be found by the search.

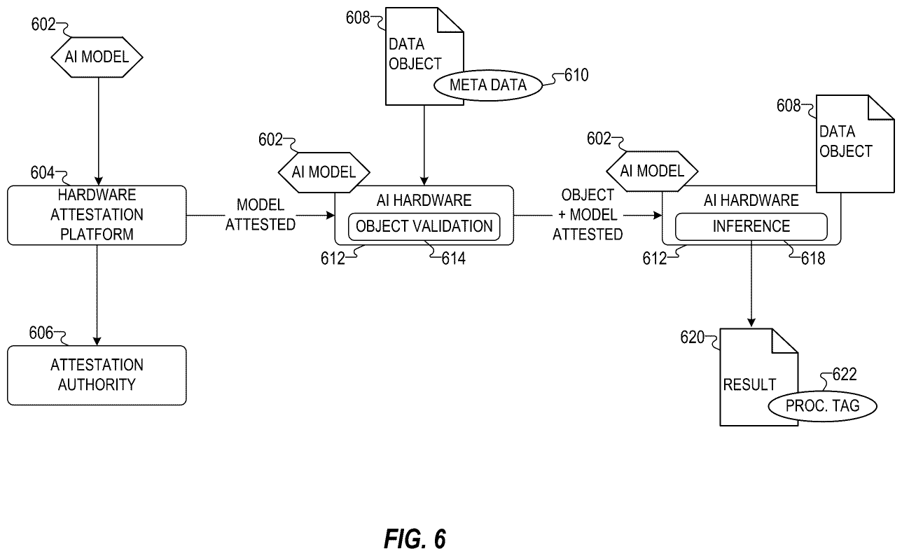

The local repository includes a record with values that match the AI model 118 and other AI models. The record can also contain a type of registration. In general, if only “registered” or “not registered” are available states, then the local repository need not maintain additional information about the registration. However, if the registration is conditional (e.g., the AI model 118 is valid for public data but not for personal data or other data type restrictions) or time restricted (e.g., the AI model registration is valid for a given month in the year or other time based restrictions), the record can include such limitations for the registered AI model 122. Additional examples with respect to AI model attestation and validation with a data object are illustrated in FIG. 6 and described below.

When the registered AI model 122 does not exist at the time of loading 120, the processing circuitry is configured to communicate the set of identifiers to the attestation authority (e.g., at computer system 126). The attestation authority is a computer system that, by definition, is trusted. This trust can be established in numerous ways, but in general can be considered predefined. The trust authority includes data and interfaces to validate the AI model 118. Thus, for example, the attestation authority was provided a tested and approved version of the AI model 118 along with a way to determine whether a query about the AI model 118 actually refers to the AI model 118. Thus, when the attestation authority receives the set of identifiers, the attestation authority can use one or more members in the set of identifiers to find (or not find) the record of the AI model 118 at the attestation authority. Some of the set of identifiers can be used to determine whether the model being verified is actually the same as that held by the attestation authority. For example, if the attestation authority had a record of the AI model 118 based on a serial number assigned by the manufacturer of the AI model 118, and the record included a cryptographic hash of the neural network weights for the AI model 118, the attestation authority could look up the record from the serial number in the set of identifiers communicated by the processing circuitry. The attestation authority can then compare the cryptographic hash in the set of identifiers to the cryptographic hash in the record. If the cryptographic hashes match, then the AI model 118 is valid (e.g., the expected correct model and version such that the weights or parameters of the AI model that produce a specific output given an input are the same), otherwise the AI model 118 is not valid. If attestation of the AI model 118 is successful (e.g., the AI model 118 is true and correct), the AI model 118 can be moved to a secure storage or memory to prevent tampering. For example, the AI accelerator 110 can include or be a controller of a memory to store the AI model 118. The access to this memory can be restricted to the identification of a model to be written, deleted, or used, thus denying access to the underlying model parameters and preventing a malicious actor from modifying a model after attestation is successful.

In general, attestation (e.g., trust attestation) refers to a process (or set of processes) of verifying the integrity or authenticity of some system(s) or component(s), to ensure that the system(s) or component(s) are trustworthy. Trustworthiness and trust overall may have different meanings depending on the operation to be accomplished, and can relate to a combination of operational aspects of data and data processing, such as: ensuring that a system and its data have not been tampered with or compromised; ensuring that a system provides privacy and secure protection of its data (e.g., for data at rest and in-transit); ensuring that a system is providing robust (e.g., complete) and accurate data; ensuring that a system is accountable and provides complete and auditable data; ensuring that a system uses explainable and transparent methods for the use of AI models; or ensuring that a system uses AI models or computations correctly and contributes federated data or processing results for distributed in an accurate, predictable, and repeatable way. Some combination of these aspects is often important for ensuring correct operations in different contexts among distributed systems.

Trust thus refers to a degree of confidence (sometimes referred to as a credibility factor or a trustworthiness measure) that some compute entity (e.g., a node, a chiplet, a platform, a server, AI model, etc.) will act in an expected manner. Such confidence may be based on any number of different factors including established protocols, reputations, cryptographic guarantees, previous interactions, etc. The actions that may be expected by the entity may relate to how the entity handles information that is provided to the entity (e.g., the information is not exfiltrated to third parties, the information is stored in a secure manner, etc.), adherence to established protocols, etc. A device may be “trusted” or considered “trustworthy” when the degree of confidence meets a trustworthiness and/or a credibility factor threshold (e.g., based on a given data variable, integer, etc.).

In an example, different factors of component operation can be weighted differently when determining the degree of confidence for the component. In an example, the determination of trustworthiness is be performed by a third party (e.g., the trusted authority). It will be understood that not only can a particular entity be assigned with a trust or a trust attribute, but additionally, trust or a trust attribute can be assigned to data, data set(s), data series, collections of data, and/or any other type of data-based information. In an example, trust or a trust attribute can be assigned to one or more location(s) where the data or any type of data-based information is stored.

Many representations of trust and trustworthiness can be expressed and maintained in a computing system through trust attributes. Trust attributes can be output as values, such as one or more numeric values, one or more text values, etc., that can be evaluated through one or more operations (e.g., comparisons, concatenations, summations, differences, hashes, etc.). For example, two or more different trust attributes can be combined to develop an overall trust value or score for a component, such as the AI model 118. In an example, the values of individual trust attributes or different combinations of trust attributes can be used to develop several composite trust value(s) or score(s) (e.g., at different hierarchical levels) for a component. In an example, trust attributes can also refer to competence attribute(s) and/or compliance attribute(s), integrity attribute(s), assurance attribute(s), validation/validity attribute(s), privacy attribute(s), reliability attribute(s), credibility attribute(s), safety attribute(s), explainability attribute(s), trustworthiness attribute(s), etc. Accordingly, the consideration of trust and trustworthiness may take a variety of forms.

Security of the communication from the processing circuitry to the attestation authority can be important to prevent man-in-the-middle attacks or other forms of manipulation in an attempt to subvert the authority of the attestation authority. Accordingly, in an example, the processing circuitry is configured to transmit the set of identifiers in a package. In an example, the processing circuitry is configured to encrypt the package. In an example, the package is encrypted with a private key of the AI accelerator 110. In this example, a process by which the AI accelerator 110 (or another chiplet) is registered with the attestation authority such that, for example, the corresponding public key, or a copy of the private key (e.g., a symmetric key) are available to the attestation authority to decrypt the package. A similar registration can occur whereby the attestation authority is registered with the AI accelerator 110 in order for a response to be decrypted. Generally, such registrations are addressed by a manufacturer of the AI accelerator or by an assembler of the chiplet package 102. In an example, the package is transmitted via the network 124 in the chiplet assembly to an external networking interface (e.g., the external component 116), for example, via the off-package interface 112.

In an example, the processing circuitry is configured to retrieve communication parameters for the attestation authority from a chiplet assembly controller for a chiplet assembly. Here, for the example, the compute tile 104 can include a TEE that hosts the communication parameters. In this example, the processing circuitry is configured to request the communication parameters from the compute tile 104. In an example, the AI accelerator 110 includes the TEE that hosts the communications parameters. In an example, the communication parameters for the attestation authority are retrieved as part of a boot sequence for the AI accelerator 110 (or other chiplet).

The processing circuitry is configured to receive a confirmation that the AI model 118 is authentic. As noted above, this confirmation is based on the attestation authority being able to find the AI model 118 attestation information within its own system based on the set of identifiers as well as to determine that the AI model 118 has not been tampered with or corrupted, based on the set of identifiers or perhaps based on additional information about the AI model 118 transmitted to the attestation authority by the processing circuitry. If the AI model 118 is not valid—for example, either the AI model 118 could not be found or the attestation authority could not determine that the AI model 118 had not been tampered with or otherwise corrupted—the attestation authority could respond with an error (e.g., a NACK or the like) or other communication indicating the attestation failure status. In an example, the response of the attestation authority for attestation failure can include a code, or other information, providing an indication or other details as to the nature of the failure (e.g., that the AI model 118 is corrupted).

When the attestation is successful, the processing circuitry is configured to register the AI model 118 in the local repository based on the attestation confirmation received from the attestation authority. As noted above, this registration includes at least recording at least one unique identifier of the AI model 118. Other aspects can include conditions of the attestation (e.g., time, place, or data restrictions) or metadata about the attestation exchange (e.g., when the attestation occurred, identifying information about the attestation authority, etc.).

In an example, following the creation of the registered AI model 122 (e.g., the AI model 118 attestation is complete), the processing circuitry is configured to execute the AI model 118. Executing the AI model 118 can include instantiating the AI model 118, performing an inference or other calculation using the AI model 118, or other uses of the AI model 118.

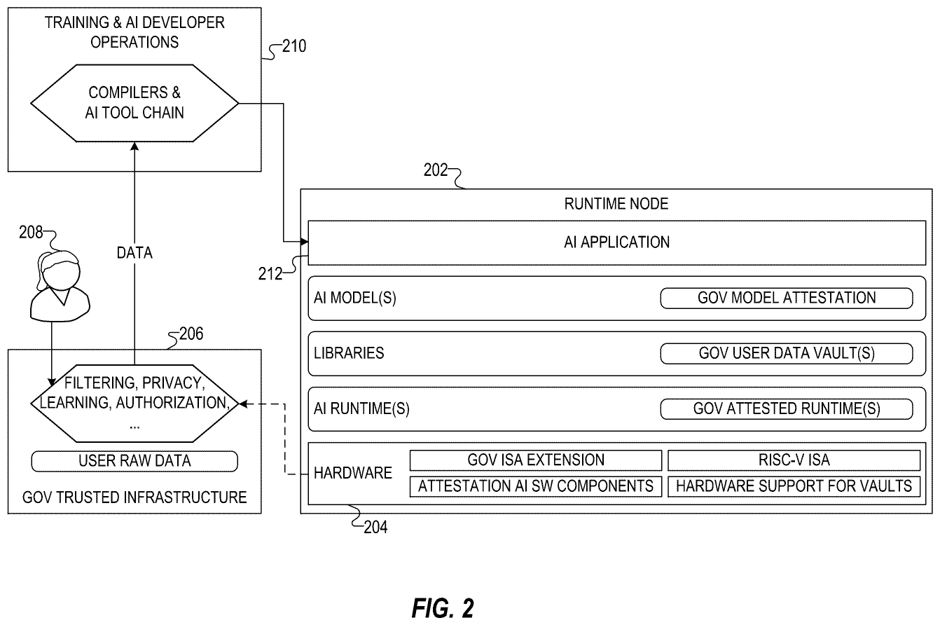

FIG. 2 depicts components interactions in AI model attestation, according to an embodiment. These components illustrate a software and hardware co-design that enables an application and or a user 208 to attest which AI models or AI runtimes are acceptable. To implement this, two elements are shown: first an external entity (server, etc.) that provides APIs that enable attestation or AI models or AI runtimes; and second, hardware APIs with which the software stack or user 208 interacts to perform hardware assisted runtime attestation for AI models or runtimes.

The illustrated example includes a user 208 interacting with a trusted authority 206 (e.g., a government service, corporate service, etc.) to specify conditions (e.g., limits, restrictions, etc.) on use of data of the user 208. When used as the attestation authority described in FIG. 1, the trusted authority 206 includes a set of APIs to enable the hardware 204 to contact the trusted authority to receive an attestation for a given AI model before using the AI model.

The trusted authority 206 can also provide information to a developer 210 of AI models. This data can be used to restrict data or actions in the training or design of an AI model based on, for example, the preferences of the user 208. Once the AI model is created, it can be used on a computer system 202 as part of an AI application 212. If this cycle is maintained, then the trusted authority 206 will positively attest to the AI model produced by the developer 210 and used in the AI application, resulting in the execution of the AI application 212 (or at least parts thereof) by the hardware 204.

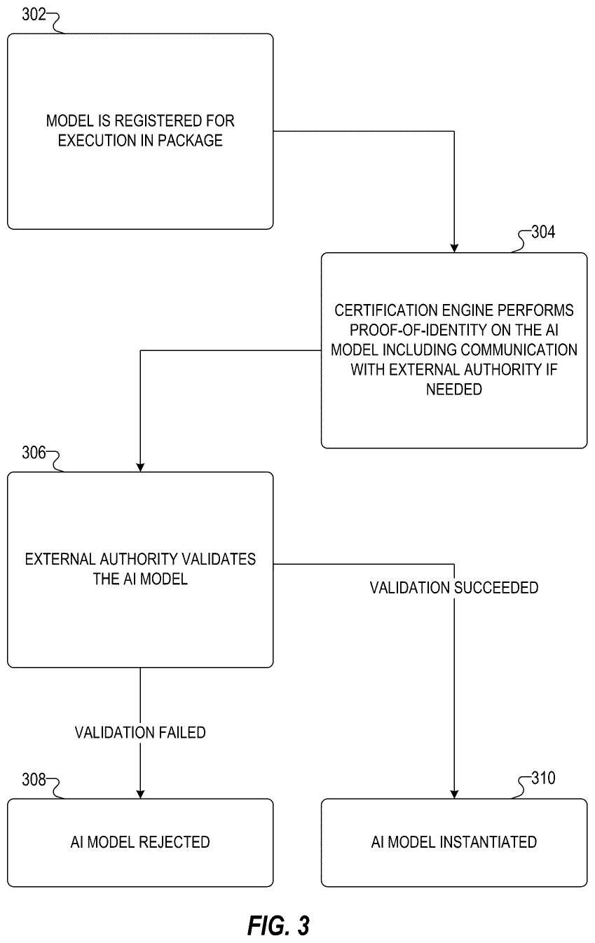

FIG. 3 depicts a processing flow for AI model attestation, according to an embodiment. The various devices, systems, or components (e.g., architectures) described herein enable the illustrated flow that enables software or owners of the devices to force Model AI or AI model runtime attestation.

At operation 302, an AI model or runtime (e.g., weights, metadata, etc.) is registered, for example, in a compute unit of a SoC or SiP. In an example, the compute unit is a chiplet, an accelerator, or a general compute tile.

At operation 304, a certification engine (e.g., processing circuitry of the compute unit) performs a hash on the AI model. The certification engine can sign (e.g., cryptographically sign) the hash model (e.g., including a timestamp) with, for example, a private key of the SiP to certify the hash. While a hash is used in this example for the proof of identity of the AI model, other techniques can be used as described above with respect to FIG. 1 or below with respect to FIG. 6 (e.g., in operation 740). The certification engine can encrypt the proof with a public key of the attestation authority and send the proof (e.g., package) to the attestation authority. In an example, the message to the attestation authority can include metadata to identify the model itself. Examples of metadata can include a universally unique identifier (UUID), version, owner, developer, etc.

The attestation authority can be implemented by one or more home nodes that have connection parameters (e.g., network addresses, ports, etc.) that are installed in the SiP. In an example, the SiP, at boot time, can be configured to contact a directory (e.g., a manufacturer's secure service) or other services to discover which attestation authorities that are reachable for the SiP.

At operation 306, the attestation authority, using the meta-data, can identify the model, get the known and valid proof for the model, and perform the attestation. The result of the attestation procedure is then transmitted back to the certification engine. If the attestation validation succeeds, the SiP will instantiate (e.g., or otherwise execute or use) the AI model (result 310). Otherwise, the AI model can be rejected (e.g., prevented from running on the SiP, erased, reported, etc.) (result 308).

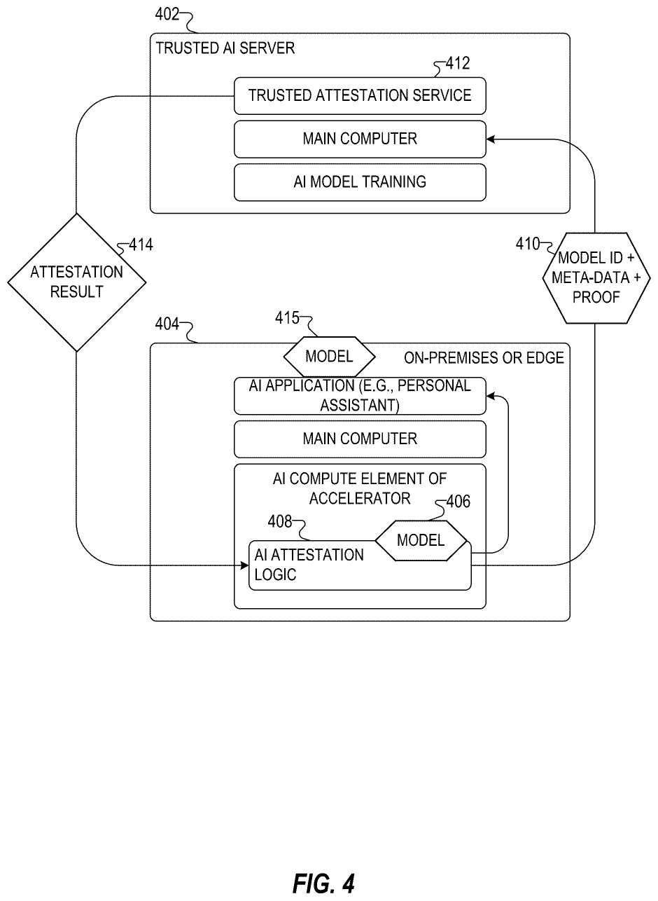

FIG. 4 depicts components interactions in AI model attestation, according to an embodiment. Here, the node 404 has a software program attempting to user the model 415. The AI accelerator of the node 404 includes attestation circuitry 408 that extracts a set of identifiers 410 of the model 415 and transmits them to the attestation authority 402 (e.g., a trusted AI server). The attestation authority 402 can be hosted in a trusted infrastructure. The attestation authority 402 can include an attestation service 412 (e.g., a set of APIs) to provide model attestation. In response to the attestation request, the attestation authority 402 can transmit the attestation result 414 to the attestation circuitry 408. If the attestation result 414 indicates that the model 415 is valid and correct, then the attestation circuitry 408 can register the model as model 406 and enable the participation of the model 406 in AI operations.

Although many of the examples discuss AI models, the same procedures can be used attest AI runtimes (e.g., elements of or the entire software stack) that execute (e.g., run) on the node 404. For example, at boot time, when the application or component thereof is loaded, or at some other point, the attestation circuitry 408 can perform the gathering of attestation data (e.g., produce a hash of the software stack) to create a proof of identify and perform the attestation.

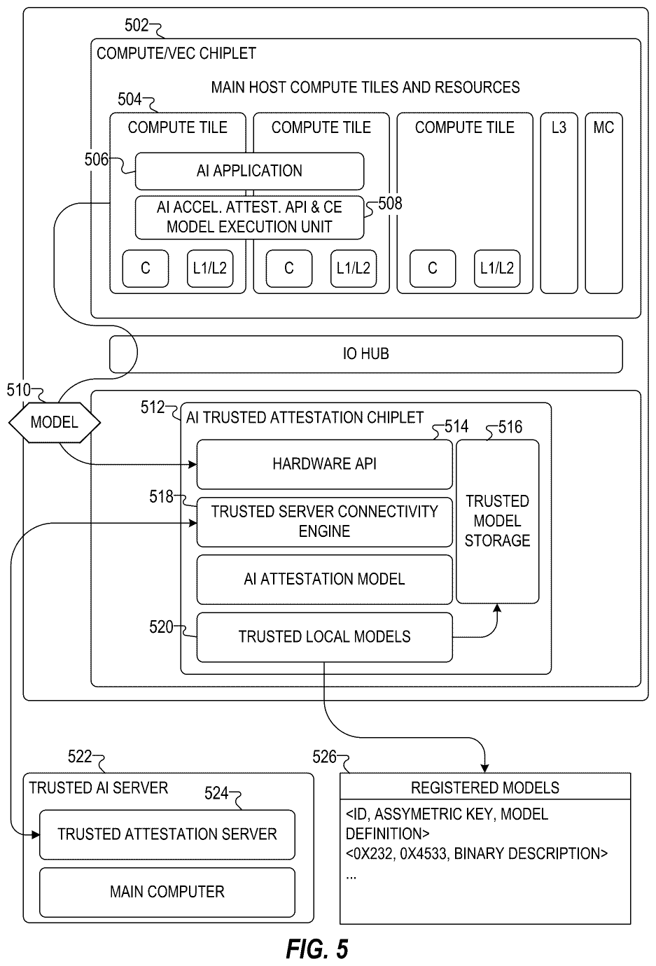

FIG. 5 depicts an example of an architecture for AI model attestation, according to an embodiment. The illustrated architecture differs somewhat from the examples described above in that the attestation circuitry is hosted in an attestation chiplet 512 of a chiplet assembly (e.g., a chiplet package). Here, a compute chiplet 502 includes a compute tile 504 that is running an AI application 506. The compute tile includes software or hardware to interface 508 with the attestation chiplet 512 to verify the model 510 for use in the AI application 506.

The attestation chiplet 512 includes a hardware interface 514 to accept an attestation request from the software or hardware interface 508 with respect to the model 510. Local model circuitry 520 can access a data structure 526 to determine whether or not the model 510 is or is not registered locally. In an example, the local model circuitry 520 can provide an attested version of the model 510 from the trusted model storage 516.

If the model 510 is not already registered (or available in the trusted model storage 516), the trusted service connectivity engine 518 can derive proof of identity (e.g., a set of identifiers) from the model 510 and contact a trusted attestation server 524 hosted as part of a trusted AI server 522 for an attestation result. The result can be used to update the data structure 526 or trusted model storage 516 if the model 510 is attested (e.g., verified, validated, etc.) by the trusted attestation server 524. If the attestation result is positive (e.g., the model 510 is locally registered or attested by the trusted attestation server 524), the AI application 506 can continue to use the model 510. Otherwise, the software or hardware interface 508 can prevent the use of the model 510 by the AI application.

FIG. 6 depicts component interaction for validating data for use with an attested AI model, according to an embodiment. The illustrated scenario pertains to situations in which a user, for example, has defined which AI models can be used with specific data (e.g., data objects). This flexibility enables, for example, greater restriction of AI models working with sensitive data (e.g., personally identifying information, corporate secret information, etc.) and broader acceptability of AI models that can work with less sensitive information (e.g., public data, demographic data that is not personally identifiable, etc.).

The illustrated scenario starts with an attempt to register the AI model 602 with the AI hardware. Here, the hardware attestation platform 604 gets access to the AI model 602—such as the AI model 602 is transmitted to the hardware attestation platform 604, a memory address for the AI model 602 is transmitted to the hardware attestation platform 604, or the like—and then the hardware attestation platform 604 derives a proof of identity (e.g. a set of identifiers) and communicates this proof of identity to the attestation authority 606.

The attestation authority 606 is a component external to the hardware attestation platform 604 (and the AI hardware 612) and maintains a facility to accept proof of identity for a component and to determine validity of the proffered proof of identity for the component. The component can be, for example, software, firmware, or hardware implementing, the AI hardware 612, the AI model 602, or any other component for which a proof of identity can be extracted. There can be different attestation authorities for different components, different types of components, or other delineations of components. Often, the attestation authority 606 is remote from a system that hosts the hardware attestation platform 604. Connectivity parameters (e.g., a network address of the attestation authority 606) can be given to the hardware attestation platform 604 during manufacture, during configuration (e.g., at system boot, at first initialization of the hardware attestation platform 604, etc.), or on-demand (e.g., the hardware attestation platform 604 has access to an orchestration component of a chiplet package that can provide one or more of the connection parameters).

As noted with respect to FIG. 1, if the attestation authority 606 validates the AI model 602, the attestation authority 606 can, in an example, provide additional restrictions or conditions on the use of the AI model 602. As previously stated, these restrictions can include time (e.g., time of day, month of year, etc.), place (e.g., within a certain country, in hardware with a certain level of security, etc.). In this case, the registration of the AI model 602 can include these restrictions that are enforced by the AI hardware 612, for example.

Alternatively, or in addition to the attestation supplied conditions for use, data, such as the data object 608, can include conditions for the data use. In the illustrated scenario, the data object 608 includes internally, or in the metadata 610, conditions for use of the data object 608. For example, the metadata 610 can specify that the AI model 602 can operate on the data object 608. Thus, for example, the AI model 602 can be registered with (e.g., loaded into) the AI hardware 612 after attestation (e.g., by the hardware attestation platform 604) at boot, when an application is loaded, etc. Then, at some later time, the data object 608 is provided (e.g., the bits are transmitted, a memory address for the location of the memory object 608, etc.) to the AI hardware 612 with a request to use the AI model 602 to perform inference (or other AI model actions) on the data object 608. The AI hardware includes an object validation component 614 that is configured to accept the metadata 610 that is attached to, or otherwise corresponds to, the data object 608, extract a condition for use of the data object 608 from the metadata 610, and validate that the AI model 602 meets the condition. The metadata 610 can, in an example, also maintain other conditions, such as on hardware requirements, or use of the results (e.g., as described below).

If the combination of the AI model 602 and the data object 608 are valid (e.g., the AI model 602 has been attested and qualifies under the conditions of use for the data object 608), then the AI hardware 612 can proceed to execute the AI model 602 to perform an inference 618 on the data object 608. The result 620 of the inference 618—or other type of activity (e.g., classification, text or image or sound generation, embedding, etc.) supported by the AI model 602—can then be used (e.g., in a calling application). The illustrated example also includes a processing tag 622, produced by the AI hardware 612 that provides a record of the execution that produce the result 620. In an example, the processing tag 622 can be signed (e.g., with a private key of the AI hardware 612).

In an example, the processing tag 622 can operate as a forensic tool to enable a downstream, consumer of the result 620 to determine that the correct version of the AI model 602 was used (e.g., via the attestation), that the AI model 602 was authorized to operate on the data object 608, that the AI hardware 612 was correct (e.g., attestation of the software or hardware implementing the AI hardware 612), and other information concerning the production of the result 620. This information can be useful, for example, in AI training data sets, where the result 620 is used for training and the provenance of the result 620 can be used to verify that the result 620 is appropriate for the training based on the AI model 602 and the data object 608.

The processing tag 622 enables automatic (e.g., without human intervention) validation of the circumstances employed to produce the result 620. Such automatic provenance enables, for example, AI agents (e.g., a workflow that includes one or more products of AI models) to assess whether a given result is appropriate for self-training. Thus, for example, the result 620 can be delivered to an AI agent with the processing tag 622. The AI agent can compare the fields (e.g., entries) of the processing tag 622 with a local set of conditions for use to determine whether the result 620 meets the use criteria of the AI agent. If the conditions are met, then the AI agent can use the result 620 as training data to further evolve the AI agent.

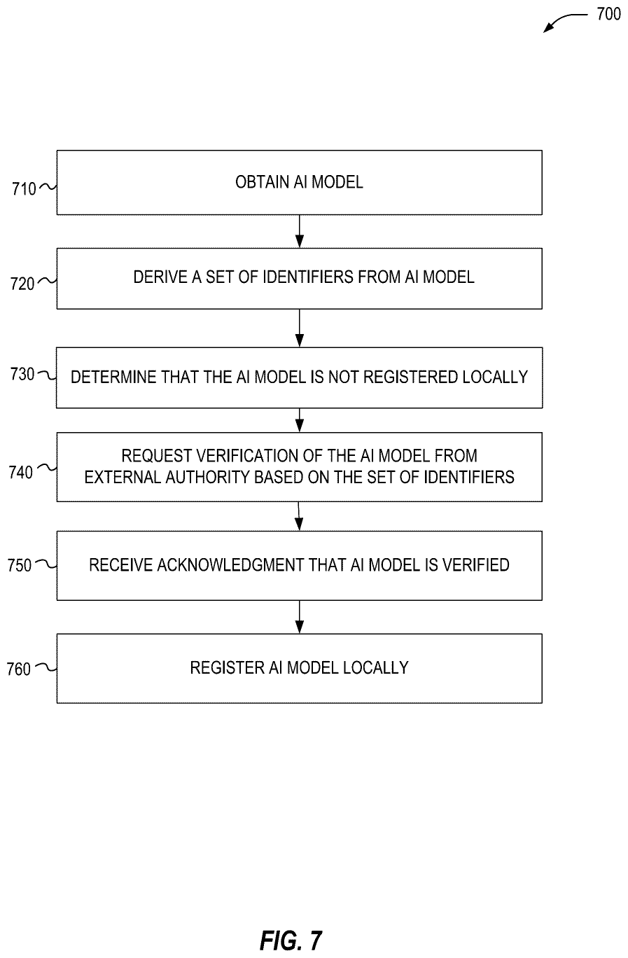

FIG. 7 depicts a method 700 for hardware assisted artificial intelligence model attestation, according to an embodiment. The operations of the method are performed by computer hardware, such as that described above or below (e.g., processing circuitry).

At operation 710, an AI model for execution on the chiplet is obtained (e.g., retrieved, received, accessed from local memory or storage, etc.).

At operation 720, a set of identifiers (e.g., a metric, measurement, fingerprint, etc.) is derived (e.g., computed, extracted, retrieved, etc.) for the AI model. In an example, the set of identifiers includes a model identifier, a version, or a producer of the model. In an example, the set of identifiers includes a hash of a portion of the AI model.

At operation 730, a local repository is searched to determine that the AI model is not registered with the chiplet.

At operation 740, the set of identifiers are communicated to an attestation authority. In an example, communicating the set of identifiers includes transmitting a package that includes the set of identifiers to the attestation authority. In an example, the package is encrypted. In an example, the package is encrypted with a private key of the chiplet. In an example, the package is transmitted via a network in the chiplet assembly to an external networking interface.

The examples with regard to operation 740 cover a number of scenarios to “fingerprint” the AI model to facilitate verification of the AI model by the attestation authority. In general, attestation operates to verify the integrity of the AI model or the authenticity. Accordingly, so proof of identity, such as the set of identifiers, is used to enable the attestation authority to judge whether the AI model is as it should be or is different (e.g., corrupted, compromised, or a different model altogether). A hash (e.g., a cryptographic hash) of the AI model can be used as proof of identity. However, collisions (e.g., two different inputs producing the same output from the hash function) are possible which can open an attack vector for malicious actors. Accordingly, the set of identifiers can include additional or alternative information to be used as the proof of identity. In an example, the set of identifiers can include the definition of the AI model or a portion of the AI model weights, parameters, or metadata. The attestation authority can request different portions for each attestation. Random selection of parameters from the AI model enables evidence of integrity without transferring the entire AI model. The attestation authority can request selected parameters by a function that uses a seed, or another function can select parameters for additional attestations.

Thus, in performing the operation 740, the processing circuitry can derive a set of identifiers for the AI model. A cryptographic hash can serve as a representation of the AI model across entities that compute the hash. Matches indicate an unaltered AI model. Non-matches indicate an altered AI model. The attestation authority can specify all or part of the AI model. The attestation authority can transmit identifiers for neuron weights or parameters or receive the corresponding data from the processing circuitry. The attestation authority can specify a function for the AI model. A comparison of results indicates whether the AI model is intact. Metadata for the AI model can include a model identifier, version, or producer. These identifiers enable a third party to confirm that the AI model is unaltered. Attestation can include performance data. This data can include results from testing input data or resource use. This data can indicate whether the AI model is corrupted. Behavior data can also reveal whether the AI model is compromised.

At operation 750, a confirmation that the AI model is authentic is received from the attestation authority.

At operation 760, the AI model is registered in the local repository based on the confirmation.

In an example, the method 700 includes the additional operation of executing the AI model based on registering the AI model.

In an example, the method 700 includes the additional operation of retrieving communication parameters for the attestation authority from a chiplet assembly controller for a chiplet assembly. In this example, the computer hardware is a chiplet with processing circuitry performing the operations of the method 700. This chiplet is in the chiplet assembly. In an example, the communication parameters for the attestation authority are retrieved as part of a boot sequence for the chiplet.

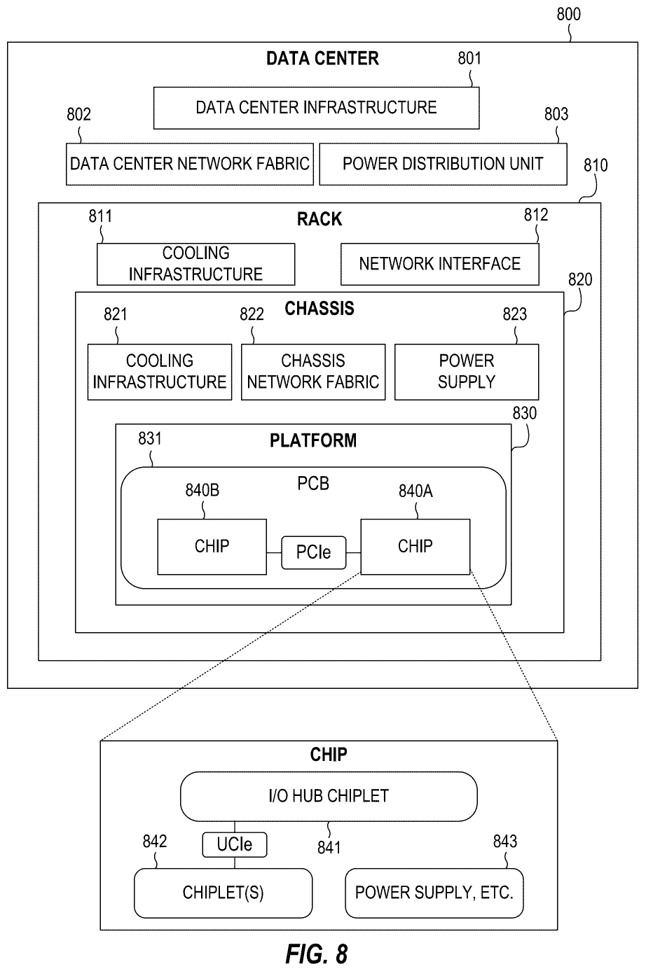

FIGS. 8, 9A, 9B, and 10 respectively depict simplified aspects of example computing architectures in which any of the techniques and configurations above may be implemented. It will be understood that the elements described above for hardware assisted AI model attestation may be integrated into various forms of the following hardware components.

FIG. 8 depicts an example hardware arrangement of a data center 800 used to provide multiple implementations or instances of a computing system (e.g., computing system 1000, discussed below), with each instance of the computing system being identified as a respective platform (e.g., platform 830). The data center 800 includes data center infrastructure 801, a data center network fabric 802, and a power distribution unit 803 to support multiple racks of compute platforms, with a single instance of a rack 810 depicted. The data center infrastructure 801 may provide physical components that host the compute platform hardware, storage components, and networking equipment; the data center network fabric 802 may include switches and networking components to support data flows among various compute platforms and storage devices throughout the data center; and the power distribution unit 803 may include components to distribute and control power among the various compute platforms, networking, and storage devices.

The rack 810 includes but is not limited to cooling infrastructure 811, a network interface 812, and related physical components (not shown) to support discrete instances of multiple chassis. The rack 810 provides power, connectivity, and cooling to each of the multiple chassis in a single rack, with a single instance of a chassis 820 depicted in FIG. 8. The chassis 820 includes but is not limited to cooling infrastructure 821, a chassis network fabric 822, and a power supply 823, which provides cooling, network connectivity, and power to multiple platforms within the chassis, with a single instance of a platform 830 depicted in FIG. 8. It will be understood that a common data center rack configuration may include dozens of chassis, with each chassis adapted to support a number of platforms depending on the physical size of the platform hardware and supporting equipment.

The platform 830 in some implementations may be referred to as a server or node, depending on the use case for the platform 830 and the data center 800. The platform 830 includes but is not limited to implementations of a discrete computing system hosted on a single board. The platform 830 is depicted as hosting a chip assembly 840A and chip assembly 840B on a first board provided by a printed circuitry board (PCB) or other platform board, shown as PCB 831. In some examples, the platform 830 may include only one chip package, whereas the PCB 831 depicts interconnection of multiple chip assemblies via a device-to-device interface (e.g., a PCI express (PCIe) or compute express link (CXL) interface). Additional chip packages and components (not shown) may also be hosted on the PCB 831.

Some implementations of the chip assembly 840A and 840B may be termed as a System-on-Chip (SoC) package, as modular chiplets that perform different functions are integrated into a single package-even though this chip package is composed of multiple dies unlike a traditional SoC design that uses a single die. Other implementations of the chip assembly 840A and 840B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 840A and chip assembly 840B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 840A is depicted as including a I/O Hub chiplet 841, chiplets 842, and a power supply 843. These components may be hosted on an interposer that is designed to connect multiple dies or components within a single semiconductor package (e.g., chip package). In some examples, the chiplets 842 may be manufactured and sourced separately and later assembled into the chip package to create the chip assembly 840A. Various connections may be provided among the chiplets 842 such as with the use of Universal Chiplet Interconnect Express (UCIe) or similar chiplet-to-chiplet interfaces and interconnects (e.g. Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced extensible Interface (AXI), and certain implementations of PCIe, CXL, etc.).

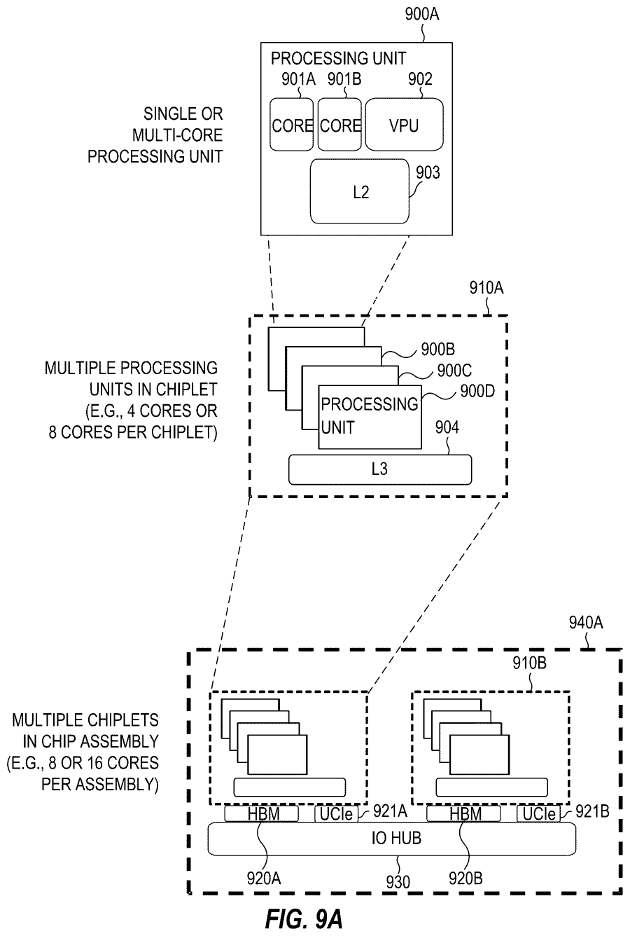

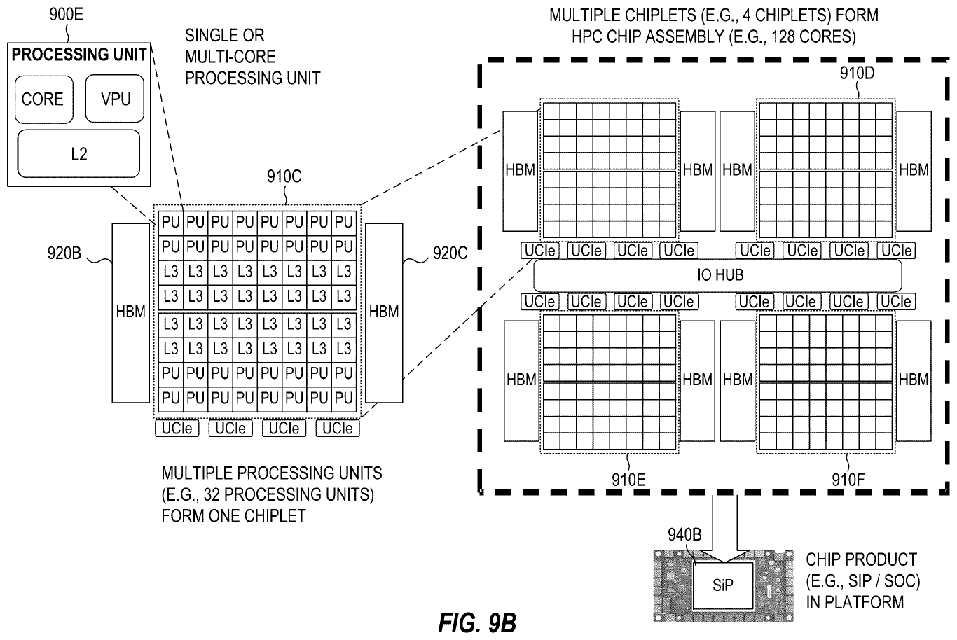

FIG. 9A depicts an example arrangement of a chip assembly 940A (e.g., a multi-processing core implementation of chip assembly 840A or 840B), with expanded views of the chiplets and processing units included therein. This arrangement shows how the chip assembly 940A, which may constitute a SoC, SoP, SiP, or other type of chip package, is composed from chiplets such as chiplet 910A, chiplet 910B, etc. and associated on-package memory (e.g., high-speed memory) such as 3D-stacked, HBM instances shown as HBM 920A, HBM 920B, interfaces (e.g., UCIe interfaces) shown as UCIe 921A, UCIe 921B, and I/O hub 930 (e.g., which may be implemented by a I/O chiplet). Other hardware elements of a chip package are not depicted for simplicity.

Each chiplet includes multiple processing units and each processing unit includes one or multiple cores. For instance, chiplet 910A as depicted includes four processing units (processing unit 900A, processing unit 900B, processing unit 900C, and processing unit 900D) and an L3 cache 904. Each processing unit may include one or multiple processing cores, one or multiple caches, and optionally other processing units or elements. For instance, processing unit 900A is depicted as including two cores (core 901A and core 901B), vector processing unit 902, and an L2 cache 903. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC) and packet switched communications, and the like.

FIG. 9B depicts an example arrangement of a chip assembly 940B (e.g., a multi-chiplet high-performance computing (HPC) implementation of chip assembly 840A, 840B), adapted for HPC applications (e.g., parallel processing operations involving thousands, millions, or more of processors or cores operating simultaneously). The example chip assembly 940B depicts placement as a SiP, SoC, or other package onto a platform board (e.g., PCB 831), and optionally in a data center (e.g., data center 800) or in a standalone deployment setting (e.g., in a standalone computer system, mobile computing device, autonomous device, etc.).

The chip assembly 940B is composed of multiple chiplets, shown with four chiplets, chiplet 910C, chiplet 910D, chiplet 910E, chiplet 910F. Each chiplet includes multiple processing units, such as 32 processing units with a corresponding L3 cache for each processing unit. Each processing unit may include one or multiple cores, such as a single-core processing unit 900E shown as part of chiplet 910C. The chip assembly 940B is also composed of corresponding memory resources, such as HBM elements corresponding to respective banks of processing units (e.g., HBM 920B and HBM 920C corresponding respective sets of processing units of chiplet 910C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configure the computing system and implementing hardware (e.g., the processing unit 900, chiplet 910, chip 840, platform 830) to perform steps and operations described above for electronic systems or devices (e.g., to perform hardware assisted AI model attestation, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

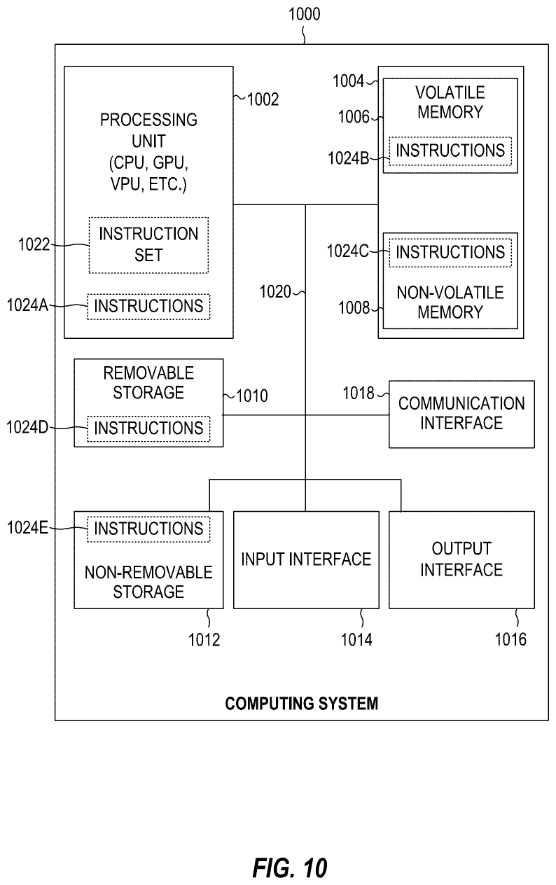

FIG. 10 depicts a block diagram of an example computing system 1000 (e.g., device, apparatus, machine, etc.) that may be programmed into a special purpose machine suitable for implementing one or more embodiments for hardware assisted AI model attestation and like aspects disclosed herein. For instance, the processing circuitry or compute sub-components described above may be embodied by the computing system 1000, such as in the form of a computer or specialized electronic device that includes sufficient processing power, memory resources, and communications throughput capability to perform operations consistent with the examples herein.

The computing system 1000 may include at least one hardware processing unit 1002 such as a central processing unit (CPU), a graphics processing unit (GPU), a vector processing unit (VPU), a neural processing unit (NPU), a hardware accelerator, or combinations or variants thereof. The at least one hardware processing unit 1002 is an implementation of processor circuitry and may be embodied by various types of chip assemblies, products, or packages as discussed with reference to FIGS. 8 to 9B. Circuitry (e.g., processing circuitry) as used herein is a collection of circuits implemented in tangible entities of the computing system 1000 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 1000 may also include at least one memory device 1004 such as volatile memory 1006 and non-volatile memory 1008, and at least one storage device such as removable storage 1010 and/or non-removable storage 1012 such as a drive unit, some or all of which may communicate with each other via an interconnect, fabric, link, or bus 1020.

The computing system 1000 may include an output interface 1016 such as an interface connected to a display device, and an input interface 1014 such as an interface connected to an alphanumeric input device or a user interface (UI) navigation device. In some examples, a connected I/O device may also include a display device, alphanumeric input device, and navigation device that is integrated into a single unit such as a touch screen display.

The computing system 1000 may additionally include a communication interface 1018, such as for connection with a network interface device used to transmit and receive electronic signals on a network. The computing system 1000 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices such as the volatile memory 1006, the non-volatile memory 1008, the removable storage 1010, or the non-removable storage 1012 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1024 with respective implementations of instructions 1024A, 1024B, 1024C, 1024D, and 1024E.

The instructions 1024 may reside, during execution or other operation of the computing system 1000, completely or at least partially within the volatile memory 1006 as instructions 1024B, within non-volatile memory 1008 as instructions 1024C, within removable storage as instructions 1024D, within non-removable storage as instructions 1024E, or within the hardware processing unit 1002 as instructions 1024A. Thus, any combination of the hardware processing unit 1002, the volatile memory 1006, the non-volatile memory 1008, or a storage device of the removable storage 1010 or non-removable storage 1012 may constitute a machine-readable medium or media. The instructions 1024A, when loaded and executed by the hardware processing unit 1002, may invoke or utilize a defined instruction set 1022 of the hardware processing unit 1002, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 1002) discussed herein.

The term “machine readable medium” may include any medium that is capable of storing, encoding, or carrying instructions for execution by components or the whole of the computing system 1000 (or a similar machine) and that cause the computing system 1000 or its components to perform any one or more of the techniques or functions described herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 1024 may further be transmitted or received over a communications network using a transmission medium via the communication interface 1018 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, or devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Additional examples of the presently described embodiments include the following, non-limiting implementations. Each of the following non-limiting examples may stand on its own or may be combined in any permutation or combination with any one or more of the other examples provided below or throughout the present disclosure.

In broad strokes, the hardware assisted artificial intelligence (AI) model attestation obtains an AI model for execution on a chiplet, derives a set of identifiers for the AI model, searches a local repository to verify that the AI model is not registered with the chiplet, communicates the identifiers to an attestation authority, receives confirmation of authenticity, or registers the AI model. The identifiers can include a model identifier, a version, or a producer, a hash, or a set of parameters for neurons in the AI model, where, in an example, the subset of neurons is randomly determined using a parameter shared with the attestation authority. The package containing the identifiers is encrypted or transmitted with a private key of the chiplet or sent over a network in a chiplet assembly. A system or device performs these operations and can, in an example, obtain communication parameters for the attestation authority from a chiplet assembly controller (or other controller), enabling execution of the AI model following a successful attestation.

Example 1 is a device for hardware assisted artificial intelligence (AI) model attestation, the device comprising: an interface configured to communicate beyond a chiplet that includes the device; a memory configured to hold a local repository; and processing circuitry configured to: obtain, via the interface, an AI model for execution on the chiplet; derive a set of identifiers for the AI model; search the local repository to determine that the AI model is not registered with the chiplet; communicate, via the interface, the set of identifiers to an attestation authority; receive a confirmation from the attestation authority that the AI model is authentic; and register the AI model in the local repository based on the confirmation.

In Example 2, the subject matter of Example 1, wherein the processing circuitry is configured to obtain communication parameters for the attestation authority from a chiplet assembly controller for a chiplet assembly to which the chiplet belongs.

In Example 3, the subject matter of Example 2, wherein the communication parameters for the attestation authority are retrieved as part of a boot sequence for the chiplet.

In Example 4, the subject matter of any of Examples 1-3, wherein the set of identifiers includes a model identifier, a version, or a producer of the AI model.

In Example 5, the subject matter of any of Examples 1-4, wherein the set of identifiers includes a hash of a portion of the AI model.

In Example 6, the subject matter of any of Examples 1-5, wherein the set of identifiers includes a set of weights or parameters for neurons in the AI model.

In Example 7, the subject matter of Example 6, wherein the set the set of weights or parameters correspond to a subset of the neurons in the AI model.

In Example 8, the subject matter of any of Examples 6-7, wherein the subset of neurons are determined randomly using a parameter shared with the attestation authority.

In Example 9, the subject matter of any of Examples 1-8, wherein the processing circuitry is configured to execute the AI model based on registering the AI model.

In Example 10, the subject matter of Example 9, wherein, to execute the AI model, the processing circuitry is configured to receive a data object to use as input for the AI model.

In Example 11, the subject matter of Example 10, wherein the processing circuitry is configured to validate that the AI model is compatible with the data object.

In Example 12, the subject matter of Example 11, wherein compatibility is based on metadata of the data object specifying that the AI model is acceptable.

In Example 13, the subject matter of any of Examples 1-12, wherein, to communicate the set of identifiers, the processing circuitry is configured to transmit a package to the attestation authority, the set of identifiers included in the package.

In Example 14, the subject matter of Example 13, wherein the package is encrypted.

In Example 15, the subject matter of Example 14, wherein the package is encrypted with a private key of the chiplet.

In Example 16, the subject matter of any of Examples 13-15, wherein the package is transmitted via a network in a chiplet assembly to an external networking interface.

In Example 17, the subject matter of any of Examples 1-16, wherein the set of identifiers includes one or more trust attributes that can include one or more competence attributes, compliance attributes, integrity attributes, assurance attributes, validation attributes, privacy attributes, reliability attributes, credibility attributes, safety attributes, explainability attributes, or trustworthiness attributes.

Example 18 is a method for hardware assisted artificial intelligence (AI) model attestation, the method comprising: obtaining, at processing circuitry of a chiplet, an AI model for execution on the chiplet; deriving a set of identifiers for the AI model; searching a local repository to determine that the AI model is not registered with the chiplet; communicating the set of identifiers to an attestation authority; receiving a confirmation from the attestation authority that the AI model is authentic; and registering the AI model in the local repository based on the confirmation.

In Example 19, the subject matter of Example 18, comprising retrieving communication parameters for the attestation authority from a chiplet assembly controller for a chiplet assembly to which the chiplet belongs.

In Example 20, the subject matter of Example 19, wherein the communication parameters for the attestation authority are retrieved as part of a boot sequence for the chiplet.

In Example 21, the subject matter of any of Examples 18-20, wherein the set of identifiers includes a model identifier, a version, or a producer of the AI model.

In Example 22, the subject matter of any of Examples 18-21, wherein the set of identifiers includes a hash of a portion of the AI model.

In Example 23, the subject matter of any of Examples 18-22, wherein the set of identifiers includes a set of weights or parameters for neurons in the AI model.

In Example 24, the subject matter of Example 23, wherein the set the set of weights or parameters correspond to a subset of the neurons in the AI model.

In Example 25, the subject matter of any of Examples 23-24, wherein the subset of neurons are determined randomly using a parameter shared with the attestation authority.

In Example 26, the subject matter of any of Examples 18-25, comprising executing the AI model based on registering the AI model.

In Example 27, the subject matter of Example 26, wherein executing the AI model includes receiving a data object to use as input for the AI model.

In Example 28, the subject matter of Example 27, comprising validating that the AI model is compatible with the data object.

In Example 29, the subject matter of Example 28, wherein compatibility is based on metadata of the data object specifying that the AI model is acceptable.

In Example 30, the subject matter of any of Examples 18-29, wherein communicating the set of identifiers includes transmitting a package to the attestation authority, the set of identifiers included in the package.

In Example 31, the subject matter of Example 30, wherein the package is encrypted.

In Example 32, the subject matter of Example 31, wherein the package is encrypted with a private key of the chiplet.

In Example 33, the subject matter of any of Examples 30-32, wherein the package is transmitted via a network in a chiplet assembly to an external networking interface.

In Example 34, the subject matter of any of Examples 18-33, wherein the set of identifiers includes one or more trust attributes that can include one or more competence attributes, compliance attributes, integrity attributes, assurance attributes, validation attributes, privacy attributes, reliability attributes, credibility attributes, safety attributes, explainability attributes, or trustworthiness attributes.

Example 35 is a machine readable medium including instruction that, when executed by processing circuitry, cause the processing circuitry to perform any method of Examples 18-33.

Example 36 is a system comprising means to perform any method of Examples 18-33.

Example 37 is a machine readable media including instructions for hardware assisted artificial intelligence (AI) model attestation, the instructions, when executed by processing circuitry of a chiplet, cause the processing circuitry to perform operations comprising: obtaining an AI model for execution on the chiplet; deriving a set of identifiers for the AI model; searching a local repository to determine that the AI model is not registered with the chiplet; communicating the set of identifiers to an attestation authority; receiving a confirmation from the attestation authority that the AI model is authentic; and registering the AI model in the local repository based on the confirmation.

In Example 38, the subject matter of Example 37, comprising retrieving communication parameters for the attestation authority from a chiplet assembly controller for a chiplet assembly to which the chiplet belongs.

In Example 39, the subject matter of Example 38, wherein the communication parameters for the attestation authority are retrieved as part of a boot sequence for the chiplet.

In Example 40, the subject matter of any of Examples 37-39, wherein the set of identifiers includes a model identifier, a version, or a producer of the AI model.

In Example 41, the subject matter of any of Examples 37-40, wherein the set of identifiers includes a hash of a portion of the AI model.

In Example 42, the subject matter of any of Examples 37-41, wherein the set of identifiers includes a set of weights or parameters for neurons in the AI model.

In Example 43, the subject matter of Example 42, wherein the set the set of weights or parameters correspond to a subset of the neurons in the AI model.

In Example 44, the subject matter of any of Examples 42-43, wherein the subset of neurons are determined randomly using a parameter shared with the attestation authority.

In Example 45, the subject matter of any of Examples 37-44, wherein the operations comprise executing the AI model based on registering the AI model.

In Example 46, the subject matter of Example 45, wherein executing the AI model includes receiving a data object to use as input for the AI model.

In Example 47, the subject matter of Example 46, wherein the operations comprise validating that the AI model is compatible with the data object.

In Example 48, the subject matter of Example 47, wherein compatibility is based on metadata of the data object specifying that the AI model is acceptable.

In Example 49, the subject matter of any of Examples 37-48, wherein communicating the set of identifiers includes transmitting a package to the attestation authority, the set of identifiers included in the package.

In Example 50, the subject matter of Example 49, wherein the package is encrypted.

In Example 51, the subject matter of Example 50, wherein the package is encrypted with a private key of the chiplet.

In Example 52, the subject matter of any of Examples 49-51, wherein the package is transmitted via a network in a chiplet assembly to an external networking interface.

In Example 53, the subject matter of any of Examples 37-52, wherein the set of identifiers includes one or more trust attributes that can include one or more competence attributes, compliance attributes, integrity attributes, assurance attributes, validation attributes, privacy attributes, reliability attributes, credibility attributes, safety attributes, explainability attributes, or trustworthiness attributes.

Example 54 is a system for hardware assisted artificial intelligence (AI) model attestation, the system comprising: means for obtaining, at processing circuitry of a chiplet, an AI model for execution on the chiplet; means for deriving a set of identifiers for the AI model; means for searching a local repository to determine that the AI model is not registered with the chiplet; means for communicating the set of identifiers to an attestation authority; means for receiving a confirmation from the attestation authority that the AI model is authentic; and means for registering the AI model in the local repository based on the confirmation.

In Example 55, the subject matter of Example 54, comprising means for retrieving communication parameters for the attestation authority from a chiplet assembly controller for a chiplet assembly to which the chiplet belongs.

In Example 56, the subject matter of Example 55, wherein the communication parameters for the attestation authority are retrieved as part of a boot sequence for the chiplet.

In Example 57, the subject matter of any of Examples 54-56, wherein the set of identifiers includes a model identifier, a version, or a producer of the AI model.

In Example 58, the subject matter of any of Examples 54-57, wherein the set of identifiers includes a hash of a portion of the AI model.

In Example 59, the subject matter of any of Examples 54-58, wherein the set of identifiers includes a set of weights or parameters for neurons in the AI model.

In Example 60, the subject matter of Example 59, wherein the set the set of weights or parameters correspond to a subset of the neurons in the AI model.

In Example 61, the subject matter of any of Examples 59-60, wherein the subset of neurons are determined randomly using a parameter shared with the attestation authority.

In Example 62, the subject matter of any of Examples 54-61, comprising means for executing the AI model based on registering the AI model.

In Example 63, the subject matter of Example 62, wherein the means for executing the AI model include means for receiving a data object to use as input for the AI model.

In Example 64, the subject matter of Example 63, comprising means for validating that the AI model is compatible with the data object.

In Example 65, the subject matter of Example 64, wherein compatibility is based on metadata of the data object specifying that the AI model is acceptable.

In Example 66, the subject matter of any of Examples 54-65, wherein the means for communicating the set of identifiers include means for transmitting a package to the attestation authority, the set of identifiers included in the package. In Example 67, the subject matter of Example 66, wherein the package is encrypted.

In Example 68, the subject matter of Example 67, wherein the package is encrypted with a private key of the chiplet.

In Example 69, the subject matter of any of Examples 66-68, wherein the package is transmitted via a network in a chiplet assembly to an external networking interface.

In Example 70, the subject matter of any of Examples 54-69, wherein the set of identifiers includes one or more trust attributes that can include one or more competence attributes, compliance attributes, integrity attributes, assurance attributes, validation attributes, privacy attributes, reliability attributes, credibility attributes, safety attributes, explainability attributes, or trustworthiness attributes.

Example 71 is at least one machine-readable medium including instructions that, when executed by processing circuitry, cause the processing circuitry to perform operations to implement of any of Examples 1-70.

Example 72 is an apparatus comprising means to implement of any of Examples 1-70.

Example 73 is a system to implement of any of Examples 1-70.

Example 74 is a method to implement of any of Examples 1-70.

What is claimed is:

1. A device for hardware assisted artificial intelligence (AI) model attestation, the device comprising:
an interface to communicate beyond a chiplet that includes the device;
a memory to hold a local repository; and
processing circuitry to:
obtain, via the interface, an AI model for execution on the chiplet;
derive a set of identifiers for the AI model;
search the local repository to determine that the AI model is not registered with the chiplet;
communicate, via the interface, the set of identifiers to an attestation authority;
receive a confirmation from the attestation authority that the AI model is authentic; and
register the AI model in the local repository based on the confirmation.

2. The device of claim 1, wherein the processing circuitry is to obtain communication parameters for the attestation authority from a chiplet assembly controller for a chiplet assembly to which the chiplet belongs.

3. The device of claim 2, wherein the communication parameters for the attestation authority are retrieved as part of a boot sequence for the chiplet.

4. The device of claim 1, wherein the set of identifiers includes a model identifier, a version, or a producer of the AI model.

5. The device of claim 1, wherein the set of identifiers includes a hash of a portion of the AI model.

6. The method of claim 1, wherein the set of identifiers includes a set of weights or parameters for neurons in the AI model.

7. The device of claim 1, wherein the processing circuitry is to execute the AI model based on registering the AI model.

8. The device of claim 1, wherein, to communicate the set of identifiers, the processing circuitry is to transmit a package to the attestation authority, the set of identifiers included in the package.

9. The device of claim 8, wherein the package is encrypted.

10. The device of claim 9, wherein the package is encrypted with a private key of the chiplet.

11. A non-transitory machine readable media including instructions for hardware assisted artificial intelligence (AI) model attestation, the instructions, when executed by processing circuitry of a chiplet, cause the processing circuitry to perform operations comprising:
obtaining an AI model for execution on the chiplet;
deriving a set of identifiers for the AI model;
searching a local repository to determine that the AI model is not registered with the chiplet;
communicating the set of identifiers to an attestation authority;
receiving a confirmation from the attestation authority that the AI model is authentic; and
registering the AI model in the local repository based on the confirmation.

12. The non-transitory machine readable media of claim 11, including retrieving communication parameters for the attestation authority from a chiplet assembly controller for a chiplet assembly to which the chiplet belongs.

13. The non-transitory machine readable media of claim 12, wherein the communication parameters for the attestation authority are retrieved as part of a boot sequence for the chiplet.

14. The non-transitory machine readable media of claim 11, wherein the set of identifiers include a model identifier, a version, or a producer of the AI model.

15. The non-transitory machine readable media of claim 11, wherein the set of identifiers includes a hash of a portion of the AI model.

16. The non-transitory machine readable medium of claim 11, wherein the set of identifiers includes a set of weights or parameters for neurons in the AI model.

17. The non-transitory machine readable media of claim 11, wherein the operations include executing the AI model based on registering the AI model.

18. The non-transitory machine readable media of claim 11, wherein communicating the set of identifiers includes transmitting a package to the attestation authority, the set of identifiers included in the package.

19. The non-transitory machine readable media of claim 18, wherein the package is encrypted.

20. The non-transitory machine readable media of claim 19, wherein the package is encrypted with a private key of the chiplet.
